(19) United States
(12) Patent Application Publication
(10) Pub. No.: US 2021/0064327 A1
(43) Pub. Date: Mar. 4, 2021

(54) AUDIO HIGHLIGHTER

(71) Applicant: Abigail Ispahani, Los Angeles, CA (US)

(72) Inventor: Abigail Ispahani, Los Angeles, CA (US)

(21) Appl. No.: 16/550,776

(22) Filed: Aug. 26, 2019

(51) Int. Cl. G06F 3/16; G10L 15/22; G10L 15/26; G06F 3/0484

(52) U.S. Cl. CPC G06F 3/165; G06F 3/0484; G10L 15/265; G10L 15/22

(57) ABSTRACT

A system and method for processing digital audio data, transcribing spoken word audio content from the digital audio data into text data, associating the text data with the digital audio data, reviewing and organizing the transcribed text, and playing back selected portions of the digital audio data associated with the transcribed text is presented. In one or more embodiments, the present invention allows a listener to mark and transcribe audio passages in, for example, a podcast or audio book, for later searching and/or reference. Thus, by analogy to use of a highlighter pen with printed text, the present invention provides an “audio highlighter” for spoken words.

### BACKGROUND OF THE INVENTION

### (1) Field of the Invention

The present invention relates generally to speech-to-text transcription systems and methods, and more particularly to a system for processing digital audio data, transcribing spoken words from the digital audio data into text data, and associating the text data with the digital audio data.

### (2) Description of the Related Art

Podcasts and audio books (“spoken word audio content”) are a convenient alternative to printed books, magazines, e-readers, display screens, and other textual methods of presenting information and entertainment. For example, a person may listen to spoken word audio content while driving, walking, exercising, working, or performing other tasks that require visual attention or the use of the hands. Furthermore, some people find it easier to learn and retain information if the information is presented as spoken word audio content instead of as text.

However, one advantage of textual materials is that the reader can mark passages of interest in the text for later reference, for example with a highlighter pen. Prior art systems and methods of presenting spoken word audio content do not provide a similar way to “highlight” audio passages that are of interest to the listener. Thus, there is a need for an “audio highlighter” that allows a listener to mark and transcribe spoken word audio passages in, for example, a podcast or audio book, for later searching and/or reference.

### BRIEF SUMMARY OF THE INVENTION

A system and method for processing digital audio data, transcribing spoken word audio content from the digital audio data into text data, associating the text data with the digital audio data, reviewing and organizing the transcribed text, and playing back selected portions of the digital audio data associated with the transcribed text is presented. In one or more embodiments, the present invention allows a listener to mark and transcribe spoken word audio passages in, for example, a podcast or audio book, for later searching and/or reference. Thus, by analogy to use of a highlighter pen with printed text, the present invention provides an “audio highlighter” for spoken word audio content.

In one or more embodiments, the system of the present invention includes a central processing unit (“CPU”), a memory that stores computer-readable instructions that implement the method of the present invention, and an audio output (for example, a speaker). In one or more embodiments, the system of the present invention may further include a video output (for example, a display screen). In one or more embodiments, the CPU, memory, audio output, and if present, video output may be included in a mobile device, such as a mobile phone, tablet computer, laptop computer, or portable audio/video player.

In one or more embodiments, the computer-readable instructions may implement the functionality of a standalone software application (an “audio highlighter application”) that allows a user to open one or more digital audio and/or video files, play back the audio and/or video stream stored therein, select time intervals in the stream for the audio to be transcribed as text, and review and organize the transcribed text. Alternatively, in one or more embodiments, the computer-readable instructions may implement the functionality of a software module or library (an “audio highlighter module” or “AHM”) that provides the above-described audio/video playback, interval selection, transcription, and review and organization functions, or any subset thereof, for use by a separate application. In one or more embodiments, the audio highlighter application may include and make use of the audio highlighter module so that the audio highlighter functionality may be provided to both the audio highlighter application and one or more third-party applications without unnecessary duplication of the computer-readable instructions.

### BRIEF DESCRIPTION OF THE DRAWINGS

The present invention may be better understood, and its features made apparent to those skilled in the art by referencing the accompanying drawings.

FIG. 1 is a flow chart showing the steps of a method for providing audio highlighter functionality of an embodiment of the present invention.

FIG. 2 shows an application user interface for marking and transcribing spoken word audio content of an embodiment of the present invention.

FIG. 3 shows an application user interface for reviewing and organizing text transcribed from spoken word audio content of an embodiment of the present invention.

The use of the same reference symbols in different drawings indicates similar or identical items.

### DETAILED DESCRIPTION OF THE INVENTION

A system and method for processing digital audio data, transcribing spoken word audio content from the digital audio data into text data, associating the text data with the digital audio data, reviewing and organizing the transcribed text, and playing back selected portions of the digital audio data associated with the transcribed text is presented. In one or more embodiments, the present invention allows a listener to mark and transcribe spoken word audio passages in, for example, a podcast or audio book, for later searching and/or reference. Thus, by analogy to use of a highlighter pen with printed text, the present invention provides an “audio highlighter” for spoken word audio content.

In one or more embodiments, the system of the present invention includes a central processing unit (“CPU”), a memory that stores computer-readable instructions that implement the method of the present invention, and an audio output (for example, a speaker). In one or more embodiments, the system of the present invention may further include a video output (for example, a display screen). In one or more embodiments, the CPU, memory, audio output, and if present, video output may be included in a mobile device, such as a mobile phone, tablet computer, laptop computer, or portable audio/video player.

In one or more embodiments, the computer-readable instructions may implement the functionality of a standalone software application (an “audio highlighter application”) that allows a user to open one or more digital audio and/or video files, play back the audio and/or video stream stored therein, select time intervals in the stream for the audio to be transcribed as text, and review and organize the transcribed text. Alternatively, in one or more embodiments, the computer-readable instructions may implement the functionality of a software module or library (an “audio highlighter module” or “AHM”) that provides the above-described audio/video playback, interval selection, transcription, and review and organization functions, or any subset thereof, for use by a separate application. In one or more embodiments, the audio highlighter application may include and make use of the audio highlighter module so that the audio highlighter functionality may be provided to both the audio highlighter application and one or more third-party applications without unnecessary duplication of the computer-readable instructions. For the purposes of this disclosure, any application that makes use of the AHM, including the audio highlighter application and the one or more third-party applications, shall be referred to as the “application”.

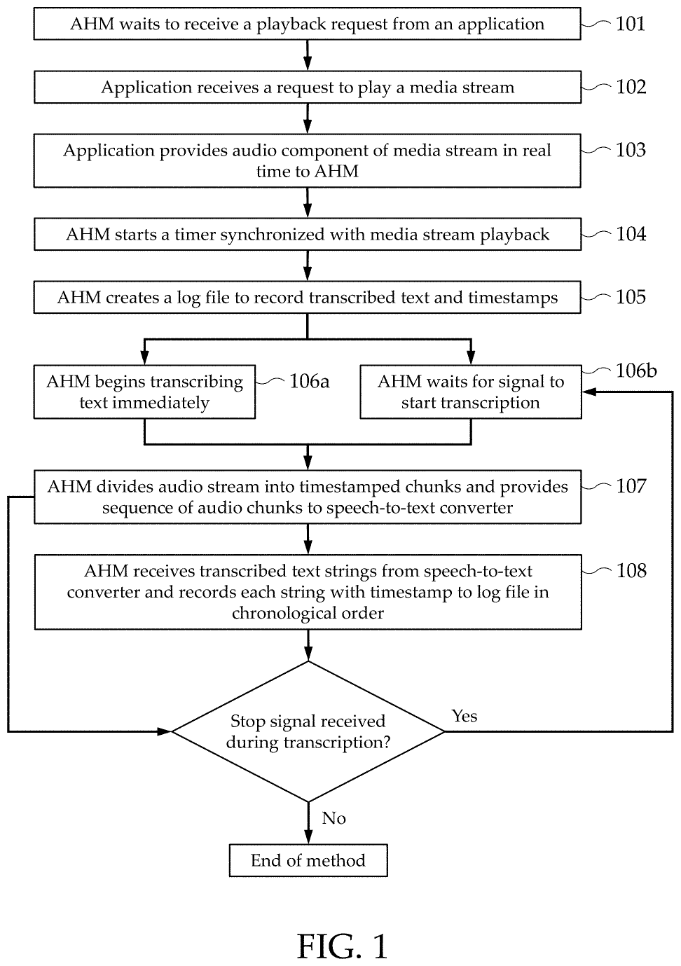

In one or more embodiments, the system and method of the present invention accepts as its input a digital audio stream and a set of one or more time intervals in the audio stream for which the speech therein shall be transcribed as text data. The set of one or more time intervals may include the entire audio stream from start to finish. In one or more embodiments, the system and method of the present invention provides as its output a log file containing the transcribed text along with one or more timestamps that link the transcribed text with its corresponding position in the audio stream. In one or more embodiments, the timestamps are recorded at constant predefined intervals. The predefined interval may be relatively long, such as every 5 seconds, which minimizes the number of timestamps and thus the amount of timestamp data recorded in the log file, but which provides only coarse-grained synchronization between the text and corresponding position in the audio stream. The predefined interval may also be much shorter, such as every 20 milliseconds, which provides much finer-grained synchronization between the text and corresponding position in the audio stream. In one or embodiments, the system and method of the present invention uses the output of the speech-to-text transcription process to record a subset of those timestamps, spaced at variable intervals, corresponding to the start of each complete sentence and/or word of the speech in the audio stream, as described in more detail below with reference to FIG. 1. In one or more embodiments, a listener may use the timestamped text as an index to seek to a desired point in the audio stream, and may then read the text as the corresponding audio plays. In one or more embodiments, the system and method of the present invention may display the text as subtitles overlaid on a video stream corresponding to the audio stream.

FIG. 1 is a flow chart showing the steps of a method for providing audio highlighter functionality of an embodiment of the present invention. The method begins at step 101. In step 101, the AHM waits to receive a playback request from an application. From step 101, the method continues to step 102. In step 102, the application receives a request from a user or from another application to play an audio and/or video file or stream (“media stream”). From step 102, the method continues to step 103. In step 103, the application provides the audio component of the media stream (the “audio stream”) in real time (i.e., at the rate it is being played back) to the AHM. In step 103, the application may perform additional actions with the media stream. For example, the application may play the audio stream through a speaker and may display a video component of the media stream, if present, on a display screen.

From step 103, the method continues to step 104. In step 104, the AHM starts a timer that measures the current time position in the playback of the media stream. The timer is maintained synchronously with the media stream playback, so for example, if playback is paused, the timer is also paused, or if the user seeks to a different position in the media stream, the timer is adjusted to the new position.

From step 104, the method continues to step 105. In step 105, the AHM creates a log file associated with the playback of the audio stream to record transcribed text, as well as timestamps that mark the position in the audio stream that corresponds to the transcribed text.

From step 105, the method continues to either step 106a or step 106b in accordance with the mode of operation selected by the user. If the user has chosen to transcribe the entire audio stream into text (for example, by selecting an option to transcribe the entire audio stream in a user interface provided by the application), the method continues to step 106a. If the user has instead chosen to transcribe selected portions of the audio stream on demand during playback (as described in more detail below), the method continues to step 106b.

In step 106a, the AHM begins transcribing spoken words from the audio stream into text immediately. From step 106a, the method continues to step 107.

In step 106b, the AHM does not begin transcribing text immediately, but instead waits for a signal from the application to start transcription. Upon receiving the signal to start transcription, the method continues to step 107.

In step 107, the AHM divides the audio stream into chunks and associates a unique timestamp with each chunk, where each timestamp corresponds to the time within the audio stream where the chunk begins. As described above, the timestamps (and their associated audio chunks) are generated at constant predefined intervals, such as every 5 seconds (providing coarse-grained synchronization between the text and corresponding position in the audio stream), or every 20 milliseconds (providing finer-grained synchronization between the text and corresponding position in the audio stream).

The AHM then provides the sequence of audio chunks to a speech-to-text converter. In one or more embodiments, the speech-to-text converter is implemented by a set of computer-readable instructions stored in the same memory, executed by the same CPU, or otherwise residing on the same computer system as that of the AHM. For example, in an embodiment, the speech-to-text converter is implemented in an offline speech recognition software library, such as those provided by recent versions of the Android or iOS operating systems. Alternatively, in one or more embodiments, the speech-to-text converter is implemented by a set of computer-readable instructions residing on a different computer system, such as a server system that provides speech-to-text transcription as a service to the AHM over a network connection. In one or more embodiments, the speech-to-text converter is implemented as a cloud-based system accessible over the Internet by the AHM, such as Google Cloud Speech-to-Text or Amazon Alexa Voice Service. In one or more embodiments, the speech-to-text conversion method may be based on a Markov model, dynamic time warping algorithm, neural network/deep learning model, or any other speech-to-text conversion method now known or later devised.

In embodiments where the speech-to-text converter resides on the same computer system as that of the AHM, the AHM sends each digital audio chunk to the speech-to-text converter for transcription, for example with an API call to an offline speech recognition software library. The speech-to-text converter transcribes the speech content of each audio chunk into a text string and returns each text string to the AHM in accordance with the conventions of the speech-to-text API.

In embodiments where the speech-to-text converter resides on a server or cloud-based system (“server”), the AHM initiates a network data connection to the server, then sends each digital audio chunk over the network data connection using a digital audio transport protocol. In one or more embodiments, the protocol may be HTTP Live Streaming (“HLS”), Dynamic Adaptive Streaming over HTTP (“DASH”), or any other digital audio transport protocol now known or later invented. Optionally, the digital audio transport protocol may include adaptive bitrate functionality to vary the digital audio stream bitrate according to the available network bandwidth. The server receives each chunk of audio data, associates a unique identifier with the chunk (for example, the AHM may provide the timestamp associated with the chunk to the server, or alternatively, the server may generate a hash code derived from the chunk's data), transcribes the speech content of the audio into a text string, and returns each text string and its associated unique identifier to the AHM over the network data connection.

From step 107, the method continues to step 108. In step 108, the AHM receives each transcribed text string (and, if using a server, the text string's unique identifier) from the speech-to-text converter. The AHM records each transcribed text string, along its associated timestamp, to the log file in chronological order.

During or after the speech-to-text conversion step, the AHM in combination with the speech-to-text converter may perform additional analysis to generate a new set of timestamps at variable intervals corresponding to the start of each complete sentence and/or word of the speech in the audio stream. For example, in an embodiment, the AHM initially generates timestamps at constant predefined intervals as described above. The speech-to-text converter recognizes and transcribes the speech in the audio stream, and returns the transcribed speech to the AHM as a set of text strings with associated timestamps, where each separate transcribed word is contained in a separate string, and each such string is associated with the timestamp nearest in time to the beginning of the identified word. Thus, the set of timestamps returned by the speech-to-text converter is a subset of the set of timestamps initially generated by the AHM. The AHM records this subset of timestamps (and associated text strings) to the log file, thereby allowing a listener to seek to any word boundary in the audio stream. Additionally, the AHM may identify sentence boundaries in the transcribed text by searching for certain punctuation characters (for example, periods, exclamation points, question marks, etc., that typically denote sentence boundaries), and record a separate “sentence boundary” timestamp in the log file at the beginning of the corresponding sentence, thereby allowing the listener to seek to any sentence boundary in the audio stream.

In steps 107 and 108, the AHM concurrently listens for a signal from the application to stop transcription. Upon receiving the signal to stop transcription, the method ensures that all transcribed text strings are recorded in the log file up to the point in time where the stop signal was received, then returns to step 106b. If no signal is received by the completion of step 108, the method ends.

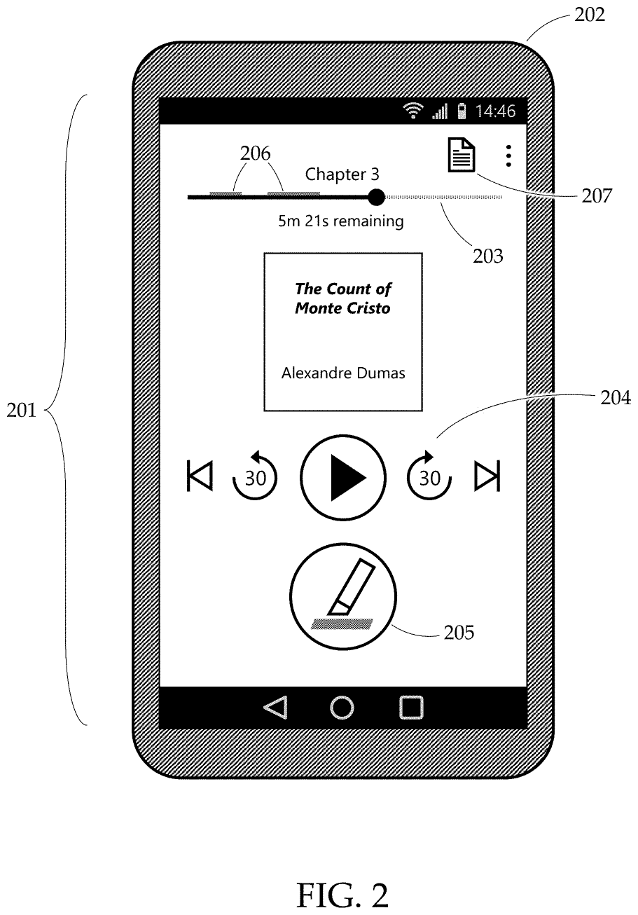

In one or more embodiments, the application provides a user interface for the user to control the start and stop of the transcription “on demand” during playback of the audio stream so that the user may choose to transcribe selected portions of the audio stream. Thus, in one or more embodiments, the transcription start and stop signals of the method shown in FIG. 1 are generated in response to input received from the user. FIG. 2 shows an application user interface 201 for marking and transcribing spoken word audio content of an embodiment of the present invention. Application user interface 201 may be provided, for example, by a podcast or audio book player application using the display screen of a mobile phone, digital media player, or similar mobile device 202. Application user interface 201 includes playback position slider 203, media playback control buttons 204, transcription control button 205, highlighted segment indicators 206, and notebook button 207. In the embodiment of FIG. 2, the start signal is generated in response to the user pressing transcription control button 205 (which is shown as a software control button displayed on the display screen of mobile device 202, but which may also or instead be a hardware control button or switch).

In the embodiment of FIG. 2, transcription control button 205 is toggleable between “on” and “off” states. The start signal is generated in response to the user pressing and releasing transcription control button 205, and the stop signal is generated in response to the user pressing and releasing transcription control button 205 a second time. In one or more alternative embodiments, the start signal may be generated in response to the user pressing and holding transcription control button 205, and the stop signal may be generated in response to the user's release of transcription control button 205 (i.e., a “hold to transcribe button”).

In one or more other embodiments, the transcription start and stop signals are generated in response to voice commands from the user, for example, “Start Highlight” and “Stop Highlight”, or are generated in response to visual or touch gestures from the user.

In the embodiment of FIG. 2, highlighted segment indicators 206 provide a visual indication of the time intervals that have been highlighted and transcribed in the audio stream. Highlighted segment indicators 206 are displayed adjacent to or overlaid on playback position slider 203, and may be displayed in a different color or with different shading from the color and/or shading of playback position slider 203. In the embodiment of FIG. 2, highlighted segment indicators 206 are displayed as line segments that span the interval from the beginning to the end of the highlighted segment. However, in one or more alternative embodiments, highlighted segment indicators 206 may be displayed as tick marks or dots indicating, for example, the beginning of the highlighted segment, which may reduce clutter when there are many highlighted segments and/or when there are overlapping highlighted segments. In the embodiment of FIG. 2, the user has highlighted two separate portions of the audio stream. In one or more embodiments, the user may tap playback position slider 203 anywhere within the bounds of a highlighted segment indicator 206, and in response, the application may seek to the beginning of the corresponding time interval in the audio stream and begin playback from that position. Additionally, a text preview (for example, an on-screen pop-up text field or text bubble) of the transcribed segment may be displayed when the user taps within the bounds of a highlighted segment indicator 206. Thus, highlighted segment indicators 206 allow the user to easily see and quickly seek to highlighted portions of the audio stream, as well as to preview the transcribed text of the highlighted portions.

In one or more embodiments, the system and method of the present invention uses the recorded timestamps to display each transcribed text segment on a display screen synchronously with audio playback. In one or more embodiments, the application sends a playback start command to the AHM, and in response, the AHM opens the log file corresponding to the media stream being played back. The AHM then starts a timer that measures the current time position in the playback of the media stream. The timer is maintained synchronously with the media stream playback, so for example, if playback is paused, the timer is also paused, or if the user seeks to a different position in the media stream, the timer is adjusted to the new position. When the value of the timer matches a recorded timestamp in the log file, the AHM passes the corresponding transcribed text to the application for display on the display screen. Alternatively, in one or more embodiments, the application may send asynchronous queries to the AHM for a list of timestamps, or for the text corresponding to a specific timestamp, instead of waiting for the AHM to send the transcribed text synchronously with the media stream playback.

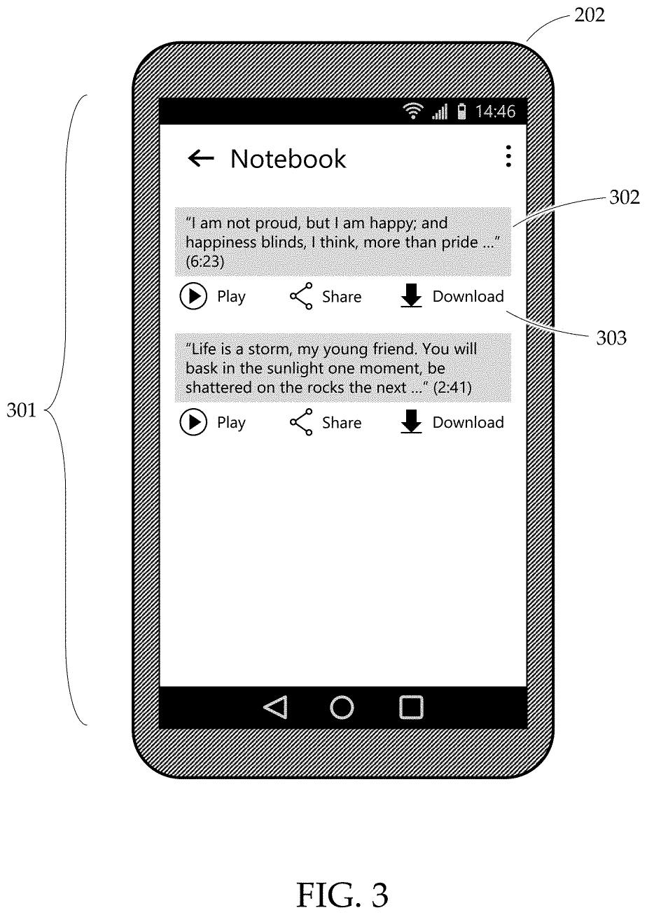

FIG. 3 shows an application user interface (the “notebook”) 301 for reviewing and organizing text transcribed from spoken word audio content of an embodiment of the present invention. Notebook 301 may be provided, for example, by a podcast or audio book player application using the display screen of mobile device 202. In the embodiment of FIG. 2, notebook button 207 allows the user to switch to notebook 301 from application user interface 201.

In the embodiment of FIG. 3, one or more transcribed text segments 302 are displayed on the display screen of mobile device 202. Below each text segment 302 is a set of action buttons 303 that allow the user to perform actions in connection with the associated text segment. For example, in the embodiment of FIG. 3, “Play”, “Share”, and “Download” buttons are provided. “Play” causes the application to play back the audio corresponding to the text segment, “Share” allows the user to share the text segment with another person or application, and “Download” allows the user to download and save an audio clip corresponding to the text segment to the mobile device. In one or more embodiments, additional actions may be provided by additional buttons, or in a context menu. For example, additional actions may allow the user to move a clip up or down in the list, delete the clip, or copy the text or timestamp to the system clipboard, among other actions.

Thus, a system and method for processing digital audio data, transcribing spoken word audio content from the digital audio data into text data, associating the text data with the digital audio data, reviewing and organizing the transcribed text, and playing back selected portions of the digital audio data associated with the transcribed text is described. Although the present invention has been described with respect to certain specific embodiments, it will be clear to those skilled in the art that the inventive features of the present invention are applicable to other embodiments as well, all of which are intended to fall within the scope of the present invention.

What is claimed is:

1. A method for providing audio highlighter functionality comprising the steps of:
receiving a digital audio stream synchronously from a digital audio playback application;
starting a timer that measures a current playback position in the digital audio stream;
creating a log file associated with the digital audio stream; and
transcribing the digital audio stream to text;
wherein the step of transcribing the digital audio stream to text comprises the substeps of:
dividing the digital audio stream into a plurality of digital audio chunks;
associating a unique timestamp with each digital audio chunk;
converting each digital audio chunk into a corresponding text string;
associating the unique timestamp of each digital audio chunk to the corresponding text string; and
recording each text string and its associated unique timestamp to the log file.

2. The method of claim 1 wherein the step of transcribing the digital audio stream to text is started in response to user input.

3. The method of claim 2 wherein the step of transcribing the digital audio stream to text is stopped in response to user input.

4. The method of claim 1 further comprising the step of providing a first user interface to display a graphical timeline representation of the digital audio stream, wherein the graphical timeline representation comprises at least one highlight mark indicating a position in the digital audio stream of the unique timestamp associated with the corresponding text string.

5. The method of claim 4 further comprising the step of starting playback of the digital audio stream from one of the unique timestamps in response to user selection of the corresponding highlight mark in the first user interface.

6. The method of claim 1 further comprising the step of providing a second user interface to display the at least one text string and its associated unique timestamp.

7. The method of claim 6 further comprising the step of starting playback of the digital audio stream from one of the unique timestamps in response to user selection of the corresponding text string in the second user interface.

8. The method of claim 1 wherein the step of converting each digital audio chunk into a corresponding text string comprises the substeps of:
sending the digital audio chunk to a speech-to-text converter;
transcribing the digital audio chunk into its corresponding text string with the speech-to-text converter; and
receiving the text string from the speech-to-text converter.

9. The method of claim 8 wherein the speech-to-text converter is located on a server computer system, wherein the step of transcribing the digital audio chunk into its corresponding text string with the speech-to-text converter is performed by the server computer system, and wherein the remaining method steps are performed by a mobile device.

10. An audio highlighter system comprising:
a microprocessor;
a memory;
computer-readable instructions stored in the memory and executing on the microprocessor; and
digital audio data stored in the memory;
wherein the audio highlighter system is configured to, in accordance with the computer readable instructions:
begin playback of the digital audio data;
start a timer that measures a current playback position in the digital audio data;
create a log file associated with the digital audio data; and
transcribe the digital audio stream to text by dividing the digital audio data into a plurality of digital audio chunks, associating a unique timestamp with each digital audio chunk, converting each digital audio chunk into a corresponding text string, associating the unique timestamp of each digital audio chunk to the corresponding text string, and recording each text string and its associated unique timestamp to the log file.

11. The audio highlighter system of claim 10 wherein the audio highlighter system is further configured to start the transcription of the digital audio stream in response to user input.

12. The audio highlighter system of claim 10 wherein the audio highlighter system is further configured to stop the transcription of the digital audio stream in response to user input.

13. The audio highlighter system of claim 10 wherein the audio highlighter system is further configured to provide a first user interface to display a graphical timeline representation of the digital audio stream, wherein the graphical timeline representation comprises at least one highlight mark indicating a position in the digital audio stream of the unique timestamp associated with the corresponding text string.

14. The audio highlighter system of claim 13 wherein the audio highlighter system is further configured to start playback of the digital audio stream from one of the unique timestamps in response to user selection of the corresponding highlight mark in the first user interface.

15. The audio highlighter system of claim 10 wherein the audio highlighter system is further configured to provide a second user interface to display the at least one text string and its associated unique timestamp.

16. The audio highlighter system of claim 15 wherein the audio highlighter system is further configured to start playback of the digital audio stream from one of the unique timestamps in response to user selection of the corresponding text string in the second user interface.

17. The audio highlighter system of claim 10 further comprising a speech-to-text converter, wherein the audio highlighter system is further configured to convert each digital audio chunk into a corresponding text string by sending the digital audio chunk to the speech-to-text converter for transcription and receiving the transcribed text string from the speech-to-text converter.

18. The audio highlighter system of claim 17 wherein the speech-to-text converter is located on a server computer system, and wherein the transcription of the digital audio chunk into its corresponding text string with the speech-to-text converter is performed by the server computer system.

19. A method for providing audio highlighter functionality comprising the steps of:
receiving a digital audio stream synchronously from a digital audio playback application;
starting a timer that measures a current playback position in the digital audio stream;
creating a log file associated with the digital audio stream;
transcribing the digital audio stream to text in response to user input;
providing a first user interface to display a graphical timeline representation of the digital audio stream, wherein the graphical timeline representation comprises at least one highlight mark indicating a position in the digital audio stream of the unique timestamp associated with the corresponding text string;
starting playback of the digital audio stream from one of the unique timestamps in response to user selection of the corresponding highlight mark in the first user interface;
providing a second user interface to display the at least one text string and its associated unique timestamp; and
starting playback of the digital audio stream from one of the unique timestamps in response to user selection of the corresponding text string in the second user interface;
wherein the step of transcribing the digital audio stream to text comprises the substeps of:
dividing the digital audio stream into a plurality of digital audio chunks;
associating a unique timestamp with each digital audio chunk;
converting each digital audio chunk into a corresponding text string;
associating the unique timestamp of each digital audio chunk to the corresponding text string; and
recording each text string and its associated unique timestamp to the log file; and
wherein the step of converting each digital audio chunk into a corresponding text string comprises the substeps of:
sending the digital audio chunk to a speech-to-text converter located on a server computer system;
transcribing the digital audio chunk into its corresponding text string with the speech-to-text converter on the server computer system; and
receiving the text string from the speech-to-text converter.
